(19) United States
(12) Patent Application Publication
(10) Pub. No.: US 2025/0077839 A1
(43) Pub. Date: Mar. 6, 2025

(54) METHOD FOR GENERATING DYNAMIC NEURAL NETWORK AND ASSOCIATED NON-TRANSITORY MACHINE-READABLE MEDIUM

(71) Applicant: MEDIATEK INC., Hsin-Chu (TW)

(72) Inventors: Chia-Hsiang Liu, Hsinchu City (TW); Cheng-Sheng Chan, Hsinchu City (TW); Min-Fong Horng, Hsinchu City (TW); Sheng-Je Hung, Hsinchu City (TW); Hung-Jen Chen, Hsinchu City (TW); Jui-Yang Hsu, Hsinchu City (TW)

(73) Assignee: MEDIATEK INC., Hsin-Chu (TW)

(21) Appl. No.: 18/239,764

(22) Filed: Aug. 30, 2023

(51) Int. Cl. G06N 3/045; G06N 3/082

(52) U.S. Cl. CPC G06N 3/045; G06N 3/082

(57) ABSTRACT

A method for generating a dynamic neural network includes: utilizing a neural architecture search (NAS) method to obtain a searched result, wherein the searched result comprises a plurality of sub-networks; combining the plurality of sub-networks to generate a combined neural network; and fine-tuning the combined neural network to generate the dynamic neural network.

### BACKGROUND

The present: invention is related to neural network architecture design, and more particularly, to a dynamic neural network that can switch model architecture without reloading or retraining.

For neural network architecture design, using a neural architecture search (NAS) method is gradually becoming a trend. For example, a searched result of the NAS method may include multiple sub-networks with better performance obtained from a pre-trained supernet, and the sub-networks can be deployed on an edge device (e.g. a mobile phone). In a certain scenario, artificial intelligence (AI) technology can be used to perform real-time video noise reduction on the edge device. The edge device, however, may be prone to overheating, so the sub-networks need to be adjusted/switched according to a working temperature of the edge device. For example, when the working temperature of the edge device is too high, a lightweight network can be selected, and when the working temperature of the edge device drops, a powerful network can be selected. Some problems may occur, however. The sub-networks deployed on the edge device need to be fine-tuned independently to reach reasonable quality, which is time-consuming. In addition, switching between the sub-networks at runtime of the edge device is also time-consuming. As a result, a dynamic neural network that can dynamically adapt network efficiency in real-time according to requirements of the edge device is urgently needed.

### SUMMARY

It is therefore one of the objectives of the present invention to provide a method for generating a dynamic neural network and an associated non-transitory machine-readable medium, to address the above-mentioned issues.

According to an embodiment of the present invention, a method for generating a dynamic neural network is provided. The method comprises: utilizing a neural architecture search (NAS) method to obtain a searched result, wherein the searched result comprises a plurality of sub-networks; combining the plurality of sub-networks to generate a combined neural network; and fine-tuning the combined neural network to generate the dynamic neural network.

According to an embodiment of the present invention, a non-transitory machine-readable medium for storing a program code, wherein when loaded and executed by a processor, the program code instructs the processor to perform a method for generating a dynamic neural network. The method comprises: utilizing a neural architecture search (NAS) method to obtain a searched result, wherein the searched result comprises a plurality of sub-networks; combining the plurality of sub-networks to generate a combined neural network; and fine-tuning the combined neural network to generate the dynamic neural network.

One of the benefits of the present invention is that, by the method of the present invention for generating a dynamic neural network, only the dynamic neural network needs to be fine-tuned, and each of switchable sub-networks for model architecture of the dynamic neural network can reach reasonable performance/quality. In addition, when there is a need to switch/adjust the model architecture of the dynamic neural network, no reload and/or retraining are required. As a result, compared with a case where multiple sub-networks are directly deployed on an edge device and the sub-networks need to be fine-tuned independently to reach reasonable quality, the method of the present invention is time-saving.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating the method for generating a dynamic neural network according to an embodiment of the present invention.

FIG. 3 shows implementation details of combining sub-networks according to an embodiment of the present invention.

FIG. 4 shows implementation details of fine-tuning a combined neural network according to an embodiment of the present invention.

FIG. 5 is a flow chart illustrating a control scheme of the method for generating a dynamic neural network according to an embodiment of the present invention.

FIG. 6 is a diagram illustrating an example of deployment of a dynamic neural network according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . .”.

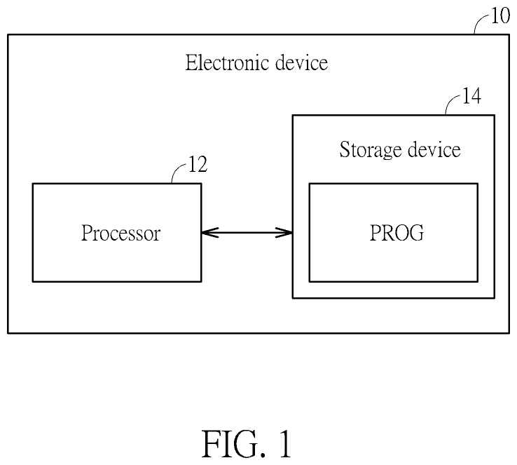

FIG. 1 is a diagram illustrating an electronic device 10 according to an embodiment of the present invention. By way of example, but not limitation, the electronic device 10 may be a portable device such as a smartphone or a tablet. The electronic device 10 may include a processor 12 and a storage device 14. The processor 12 may be a single-core processor or a multi-core processor. The storage device 14 is a non-transitory machine-readable medium, and is arranged to store computer program code PROG. The processor 12 is equipped with software execution capability. The computer program code PROG may include a neural network optimization algorithm (e.g. a neural architecture search (NAS) algorithm). When loaded and executed by the processor 12, the computer program code PROG instructs the processor 12 to perform a method for generating a dynamic neural network DNN as proposed by the present invention. The electronic device 10 may be regarded as a computer system using a computer program product that includes a computer-readable medium containing the computer program code PROG. That is, the method of the present invention may be embodied on the electronic device 10.

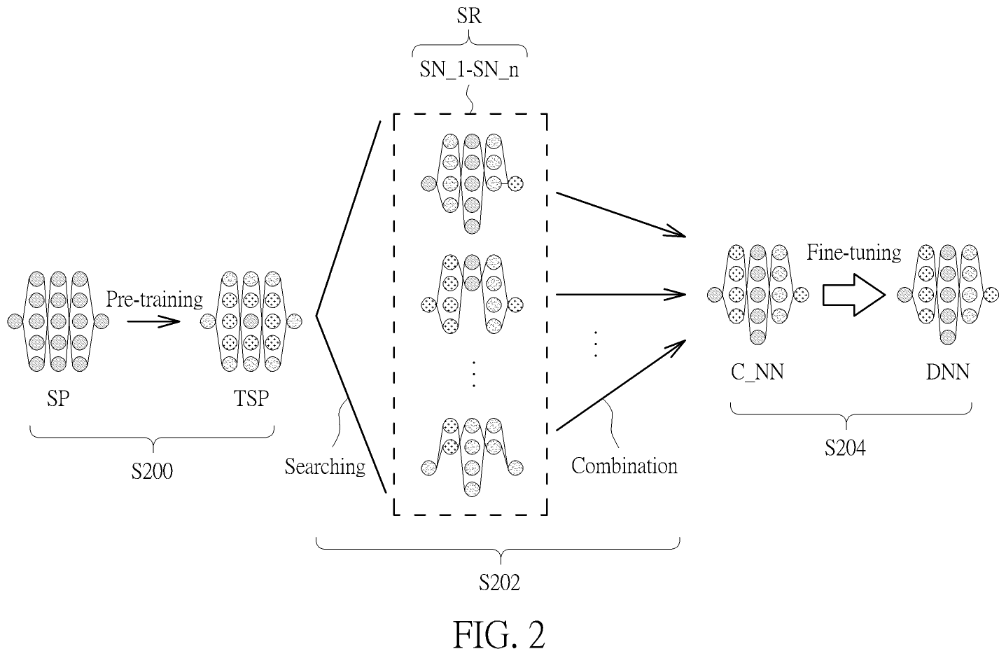

FIG. 2 is a diagram illustrating the method for generating the dynamic neural network DNN according to an embodiment of the present invention. Provided that the result is substantially the same, the steps are not required to be executed in the exact order shown in FIG. 2. For example, the method shown in FIG. 2 may be employed by the electronic device 10 shown in FIG. 1.

In Step S200, a supernet SP may be pre-trained to generate a trained supernet TSP. For example, the supernet SP/trained supernet TSP may include multiple sub-networks, and the sub-networks may share a model weight. In addition, it is assumed that the supernet SP/trained supernet TSP has 5 convolution layers, wherein a number of channels of the 5 convolution layers is 1, 5, 5, 5, 1, respectively.

In Step S202, a NAS method may be performed upon the trained supernet TSP to obtain a searched result SR, wherein the searched result SR may include a plurality of sub-networks SN_1-SN_n with better performance, and “n” is an integer greater than 1. Afterwards, the sub-networks SN_1-SN_n may be combined to generate a combined neural network C_NN for subsequent processing, wherein the combined neural network C_NN may be a supernet including the sub-networks SN_1-SN_n, the sub-networks SN_1-SN_n share a model weight MW, and model architecture of the combined neural network C_NN can be switched/adjusted between the sub-networks SN_1-SN_n.

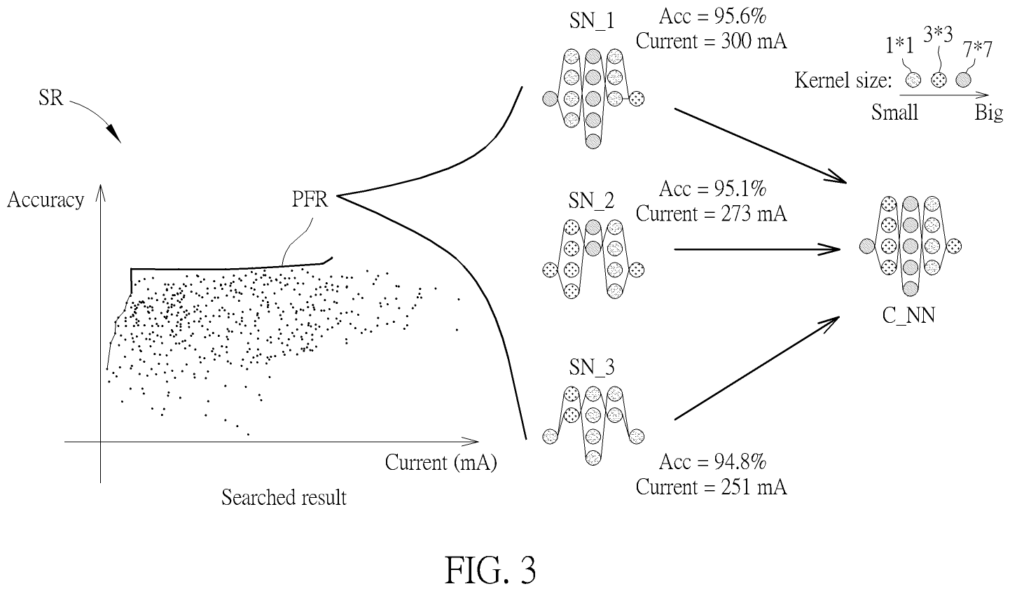

Specifically, please refer to FIG. 3. FIG. 3 shows implementation details of combining the sub-networks SN_1-SN_n according to an embodiment of the present invention. As shown in FIG. 3, a diagram in the left half of FIG. 3 may represent the searched result SR, wherein each point in the diagram may be a searched sub-network, the diagram has a horizontal axis showing power consumption of searched sub-networks in units of current, a vertical axis showing accuracy of the searched sub-networks, and the closer a searched sub-network is to the upper left corner of the diagram, the better the performance/quality of the searched sub-network with high accuracy and low power consumption is. It should be noted that a pareto-front result PFR may be obtained from the searched result SR, and the pareto-front result PFR includes the sub-networks SN_1-SN_n with better performance. That is, the combined neural network C_NN is generated according to the pareto-front result PFR.

In this embodiment, each of the sub-networks SN_1-SN_n may have 5 convolution layers, and the convolution layers may have different kernel sizes and different numbers of channels. For example, a kernel size of each convolution layer in each of the sub-networks SN_1-SN_n may be 1*1, 3*3, or 7*7. In addition, each of the sub-networks SN_1-SN_n may have a respective DNA sequence, and the DNA sequence may record model architecture of said each of the sub-networks SN_1-SN_n. For example, the DNA sequence may record channel width and kernel size of each convolution layer of a sub-network. For better comprehension, in this embodiment, the combined neural network C_NN is generated by combining the sub-networks SN_1-SN_3 (i.e. n=3), but the present invention is not limited thereto. Assuming that the accuracy of the sub-networks SN_1-SN_3 is 95.6%, 95.1%, and 94.8%, respectively (for brevity, labeled as “Acc=95.6%”, “Acc=95.18”, and “Acc=94.8%”, respectively, in FIG. 3), and the power consumption of the sub-networks SN_1-SN_3 is 300 mA, 273 mA, and 251 mA, respectively (for brevity, labeled as “Current=300 mA”, “Current=273 mA”, and “Current=251 mA”, respectively, in FIG. 3).

In detail, in order to combine the sub-networks SN_1-SN_3 to generate the combined neural network C_NN, for each convolution layer of the combined neural network C_NN, a maximum kernel size of a convolution layer among multiple corresponding convolution layers of the sub-networks SN_1-SN_3 is selected as a kernel size of said each convolution layer of the combined neural network C_NN. For example, under a condition that the kernel size of the first convolution layers (e.g. the leftmost convolution layers) of the sub-networks SN_1-SN_3 is 7*7, 3*3, and 1*1, respectively, the kernel size “7*7” will be selected as a kernel size of the first convolution layer of the combined neural network C_NN. For another example, under a condition that the kernel size of the second convolution layers of the sub-networks SN_1-SN_3 is 1*1, 3*3, and 3*3, respectively, the kernel size “3*3” will be selected as a kernel size of the second convolution layer of the combined neural network C_NN. For another example, under a condition that the kernel size of the third convolution layers of the sub-networks SN_1-SN_3 is 7*7, 7*7, and 1*1, respectively, the kernel size “7*7” will be selected as a kernel size of the third convolution layer of the combined neural network C_NN. For brevity, similar descriptions for the fourth convolution layer and the fifth convolution layer are omitted here.

In addition, for each convolution layer of the combined neural network C_NN, a maximum number of channels of a convolution layer among multiple corresponding convolution layers of the sub-networks SN_1-SN_3 is selected as a number of channels of said each convolution layer of the combined neural network C_NN. For example, under a condition that all of the number of channels of the first convolution layers of the sub-networks SN_1-SN_3 is 1, the maximum number of channels “1” will be selected as a number of channels of the first convolution layer of the combined neural network C_NN. For another example, under a condition that the number of channels of the second convolution layers of the sub-networks SN_1-SN_3 is 4, 4, 2, respectively, the maximum number of channels “4” will be selected as a number of channels of the second convolution layer of the combined neural network C_NN. For another example, under a condition that the number of channels of the third convolution layers of the sub-networks SN_1-SN_3 is 5, 2, 4, respectively, the maximum number of channels “5” will be selected as a number of channels of the third convolution layer of the combined neural network C_NN. For brevity, similar descriptions for the fourth convolution layer and the fifth convolution layer are omitted here.

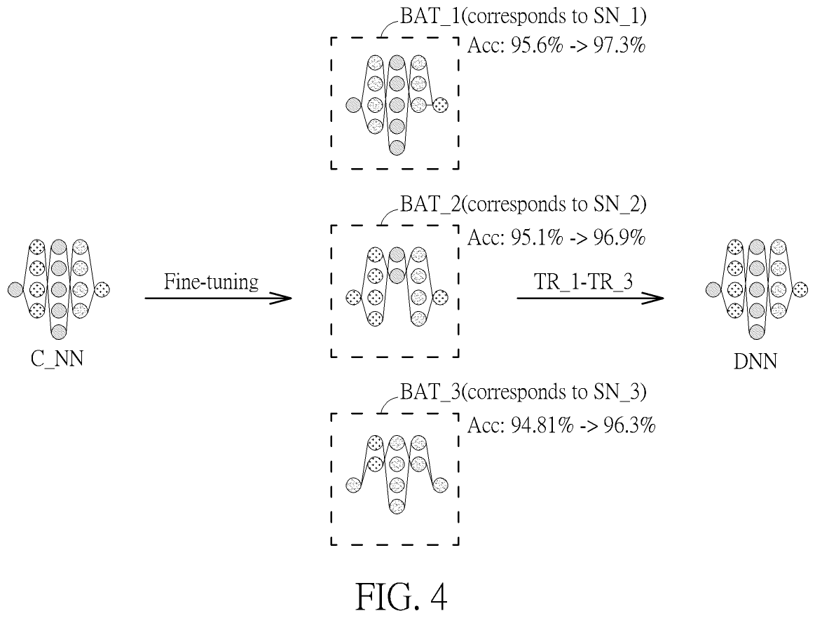

Refer back to FIG. 2. In Step S204, after the combined neural network C_NN is generated by combining the sub-networks SN_1-SN_n, the combined neural network C_NN is fine-tuned to generate the dynamic neural network DNN. Specifically, please refer to FIG. 4. FIG. 4 shows implementation details of fine-tuning the combined neural network C_NN according to an embodiment of the present invention. In this embodiment, at least one candidate sub-network is randomly sampled from the searched result SR (more particularly, the pareto-front result PFR included in the searched result SR), wherein the at least one candidate sub-network may be any of the sub-networks SN_1-SN_n. For example, the above-mentioned sub-networks SN_1-SN_3 are randomly sampled from the pareto-front result PFR as 3 candidate sub-networks. Afterwards, the combined neural network C_NN is trained in multiple batches BAT_1-BAT_M until the performance/quality of the combined neural network C_NN reaches a predetermined performance/quality, wherein M is an integer greater than 1, and each batch corresponds to one of the at least one candidate sub-network. For each of the batches BAT_1-BAT_M, a corresponding candidate sub-network is trained for updating the model weight MW of the combined neural network C_NN, to generate a trained result. That is, for the batches BAT_1-BAT_M, multiple trained results TR_1-TR_M are generated for obtaining the dynamic neural network DNN.

Assume that the combined neural network C_NN is trained in batches BAT_1-BAT_3 (e.g. M=3), wherein the batch BAT_1 corresponds to the sub-network SN_1, the batch BAT_1 corresponds to the sub-network SN_2, and the batch BAT_3 corresponds to the sub-network SN_3. For the batch BAT_1, the sub-network SN_1 is trained for updating the model weight MW of the combined neural network C_NN, to generate a train result TR_1, wherein the accuracy of the sub-network SN_1 is updated from 95.6% to 97.3% (for brevity, labeled as “Acc: 95.6%−>97.3%” in FIG. 4). For the batch BAT_2, the sub-network SN_2 is trained for keeping updating the model weight MW of the combined neural network C_NN, to generate a train result TR_2, wherein the accuracy of the sub-network SN_2 is updated from 95.1% to 96.9% (for brevity, labeled as “Acc: 95.1%−>96.9%” in FIG. 4). For the batch BAT_3, the sub-network SN_3 is trained for keeping updating the model weight MW of the combined neural network C_NN, to generate a train result TR_3, wherein the accuracy of the sub-network SN_3 is updated from 94.81% to 96.3% (for brevity, labeled as “Acc: 94.81%−>96.3%” in FIG. 4). After the model weight MW of the combined neural network C_NN is updated by training the sub-network SN_3, the performance/quality of the combined neural network C_NN reaches a predetermined performance/quality. In this way, the dynamic neural network DNN that is a well-trained supernet with an updated model weight UMW can be obtained according to the trained results TR_1-TR_3 (e.g. M=3), wherein the dynamic neural network DNN includes trained version of the sub-networks SN_1-SN_3, and the updated model weight UMW is shared between the trained version of the sub-networks SN_1-SN_3.

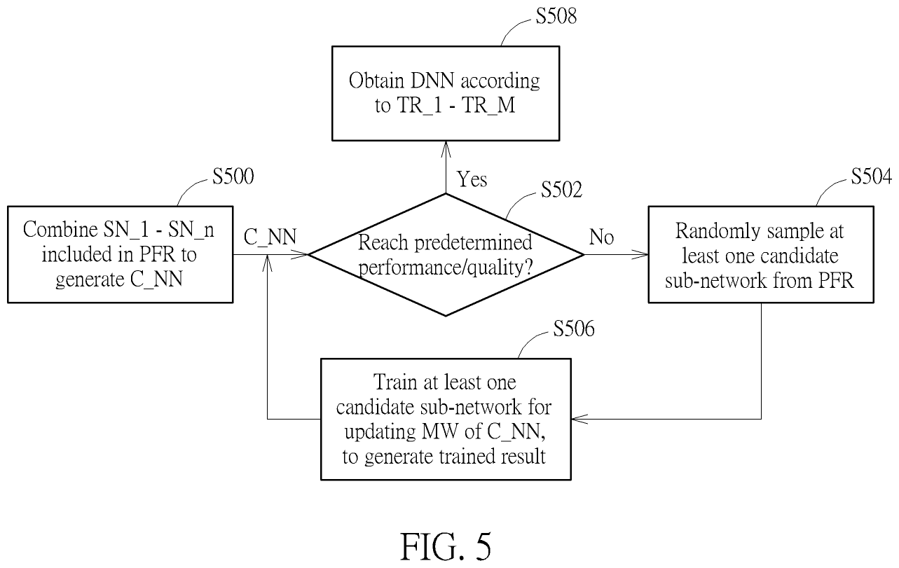

FIG. 5 is a flow chart illustrating a control scheme of the method for generating the dynamic neural network DNN according to an embodiment of the present invention. Provided that the result is substantially the same, the steps are not required to be executed in the exact order shown in FIG. 5. For example, the control scheme shown in FIG. 5 may be employed by the electronic device 10 shown in FIG. 1.

In Step S500, the sub-networks SN_1-SN_n included in the pareto-front result PFR are combined to generate the combined neural network C_NN.

In Step S502, it is determined that whether a performance/quality of the combined neural network C_NN reaches a predetermined performance/quality. If yes, Step S508 is entered; if no, Step S504 is entered.

In Step S504, at least one candidate sub-network is randomly sampled from the pareto-front result PFR. For example, the at least one candidate sub-network may be any of the sub-networks SN_1-SN_n.

In Step S506, the at least one candidate sub-network is trained for updating the model weight MW of the combined neural network C_NN, to generate at least one trained result.

In Step S508, the dynamic neural network DNN is obtained according to the at least one trained result.

Since a person skilled in the pertinent art can readily understand details of the steps after reading above paragraphs directed to the method shown in FIG. 2, further descriptions are omitted here for brevity.

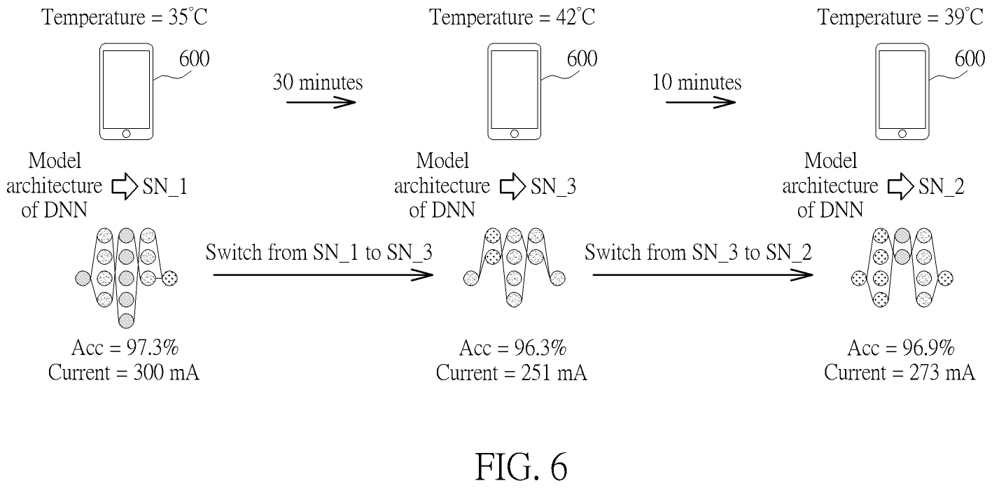

FIG. 6 is a diagram illustrating an example of deployment of the dynamic neural network DNN according to an embodiment of the present invention. As shown in FIG. 6, the dynamic neural network DNN is deployed on an edge device (e.g. a mobile phone 600) for real-time video noise reduction. In the beginning, a working temperature of the mobile phone 600 is 35° C. and the model architecture of the dynamic neural network DNN is the sub-network SN_1 with accuracy of 97.3% and power consumption of 300 mA. After 30 minutes, the working temperature of the mobile phone 600 increases from 35° C. to 42° C. Under this condition, in order to prevent the mobile phone 600 from overheating, the model architecture of the dynamic neural network DNN can be switched/adjusted according to the DNA sequences. For example, the model architecture of the dynamic neural network DNN can be switched from the sub-network SN_1 to a lightweight network (e.g. the sub-network SN_3 with accuracy of 96.3% and power consumption of 251 mA), to make the working temperature of the mobile phone 600 drop. After 10 minutes, the working temperature of the mobile phone 600 decreases from 42° C. to 39° C. Under this condition, the model architecture of the dynamic neural network DNN can be switched/adjusted again according to the DNA sequences, to enhance the effect of real-time video noise reduction. For example, the model architecture of the dynamic neural network DNN can be switched from the sub-network SN_3 to a powerful network (e.g. the sub-network SN_2 with accuracy of 96.9% and power consumption of 273 mA).

In summary, by the method of the present invention for generating the dynamic neural network DNN, only the dynamic neural network DNN needs to be fine-tuned, and each of switchable sub-networks for model architecture of the dynamic neural network DNN can reach reasonable performance/quality. In addition, when there is a need to switch/adjust the model architecture of the dynamic neural network DNN, no reload and/or retraining are required. As a result, compared with a case where multiple sub-networks are directly deployed on an edge device and the sub-networks need to be fine-tuned independently to reach reasonable quality, the method of the present invention is time-saving.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating a dynamic neural network, comprising:
utilizing a neural architecture search (NAS) method to obtain a searched result, wherein the searched result comprises a plurality of sub-networks;
combining the plurality of sub-networks to generate a combined neural network; and
fine-tuning the combined neural network to generate the dynamic neural network.

2. The method of claim 1, wherein the searched result is a pareto-front result.

3. The method of claim 1, wherein the dynamic neural network is a supernet with a model weight, and the model weight is shared between the plurality of sub-networks included in the dynamic neural network.

4. The method of claim 1, wherein the step of combining the plurality of sub-networks to generate the combined neural network comprises:
for each convolution layer of the combined neural network, selecting a maximum kernel size of a convolution layer among multiple corresponding convolution layers of the plurality of sub-networks as a kernel size of said each convolution layer of the combined neural network.

5. The method of claim 1, wherein the step of combining the plurality of sub-networks to generate the combined neural network comprises:
for each convolution layer of the combined neural network, selecting a maximum number of channels of a convolution layer among multiple corresponding convolution layers of the plurality of sub-networks as a number of channels of said each convolution layer of the combined neural network.

6. The method of claim 1, wherein each of the plurality of sub-networks has a DNA sequence, and the DNA sequence records a model architecture of said each of the plurality of sub-networks.

7. The method of claim 1, wherein the step of fine-tuning the combined neural network to generate the dynamic neural network comprises:
randomly sampling at least one candidate sub-network from the searched result;
training the at least one candidate sub-network for updating a model weight of the combined neural network until a quality of the combined neural network reaches a predetermined quality, to generate at least one trained result; and
obtaining the dynamic neural network according to the at least one trained result.

8. A non-transitory machine-readable medium for storing a program code, wherein when loaded and executed by a processor, the program code instructs the processor to perform a method for generating a dynamic neural network, and the method comprises:
utilizing a neural architecture search (NAS) method to obtain a searched result, wherein the searched result comprises a plurality of sub-networks;
combining the plurality of sub-networks to generate a combined neural network; and
fine-tuning the combined neural network to generate the dynamic neural network.

9. The non-transitory machine-readable medium of claim 8, wherein the searched result is a pareto-front result.

10. The non-transitory machine-readable medium of claim 8, wherein the dynamic neural network is a supernet with a model weight, and the model weight is shared between the plurality of sub-networks included in the dynamic neural network.

11. The non-transitory machine-readable medium of claim 8, wherein the step of combining the plurality of sub-networks to generate the combined neural network comprises:
for each convolution layer of the combined neural network, selecting a maximum kernel size of a convolution layer among multiple corresponding convolution layers of the plurality of sub-networks as a kernel size of said each convolution layer of the combined neural network.

12. The non-transitory machine-readable medium of claim 8, wherein the step of combining the plurality of sub-networks to generate the combined neural network comprises:
for each convolution layer of the combined neural network, selecting a maximum number of channels of a convolution layer among multiple corresponding convolution layers of the plurality of sub-networks as a number of channels of said each convolution layer of the combined neural network.

13. The non-transitory machine-readable medium of claim 8, wherein each of the plurality of sub-networks has a DNA sequence, and the DNA sequence records a model architecture of said each of the plurality of sub-networks.

14. The non-transitory machine-readable medium of claim 8, wherein the step of fine-tuning the combined neural network to generate the dynamic neural network comprises:
randomly sampling at least one candidate sub-network from the searched result;
training the at least one candidate sub-network for updating a model weight of the combined neural network until a quality of the combined neural network reaches a predetermined quality, to generate at least one trained result; and
obtaining the dynamic neural network according to the at least one trained result.
